(19) United States
(12) Patent Application Publication
(10) Pub. No.: US 2026/0148240 A1
(43) Pub. Date: May 28, 2026

(54) GUIDED INTERACTIVE USER-SUPPORT SYSTEM FOR A PLATFORM

(71) Applicant: DevRev, Inc., Palo Alto, CA (US)

(72) Inventor: Ribhu Chawla, Bengaluru (IN)

(73) Assignee: DevRev, Inc., Palo Alto, CA (US)

(21) Appl. No.: 18/959,054

(22) Filed: Nov. 25, 2024

(51) Int. Cl. G06Q 30/015; G06Q 30/0282

(52) U.S. Cl. CPC G06Q 30/015; G06Q 30/0282

(57) ABSTRACT

The invention provides a guided interactive user-support system for a platform is provided. The system includes a user interface that is configured to receive a user query corresponding to a desired task to be performed on the platform. The system further includes an artificial intelligence (AI) driven module that is configured to provide guided support to the user for the desired task. The AI-driven module is further configured to analyze the user query and identify one or more actions corresponding to the user query. The AI-driven module is further configured to generate one or more videos and/or texts based on the identified actions to address the user query. The AI-driven module is further configured to receive feedback from the user on the generated videos and/or texts via the user interface. The AI-driven module is further configured to generate modified videos and/or texts based on the received feedback.

### FIELD OF INVENTION

Embodiments of the present disclosure relate to software platforms, and more particularly to, an intelligent artificial intelligence (AI) based platform with guided user support.

### BACKGROUND

In the modern digital landscape, software platforms, and software applications are integral to cater to a wide range of activities, from personal productivity to professional operations. As these platforms become increasingly complex, users often encounter challenges that require timely and effective support.

Traditionally, user support to such platforms has been provided through means such as static help documents, user manuals, FAQs, and customer service centers. While these resources offer valuable information, they often fall short of providing the immediate, context-specific assistance that users may require. Static documents can be difficult to navigate and may not be up to date with the latest software changes. Customer service centers, on the other hand, may have long waiting times for the users and are not always available around the clock.

With the rapid advancement in artificial intelligence (AI) and machine learning (ML), there is a potential to revolutionize user support systems. AI can process large amounts of data, recognize patterns, and learn from interactions, making it possible to create support systems that are both dynamic and responsive. AI can analyze user behavior, understand natural language, and provide personalized assistance, thereby enhancing user experiences.

Despite these technological advancements, existing AI-driven support systems lack the integration and intuitive design necessary to fully meet user expectations. Users typically have to navigate separate interfaces or applications to access support, which can disrupt their workflow and reduce efficiency. Furthermore, while some systems respond to user queries with texts, they cannot directly guide users through actions on their screens, which is often necessary for resolving more complex issues.

### SUMMARY

The following description is illustrative only and is not intended to be in any way limiting. In addition to the illustrative aspects, example embodiments, and features described, further aspects, example embodiments, and features will become apparent by reference to the drawings and the following detailed description.

Briefly, according to an example embodiment, a guided interactive user-support system for a platform is provided. The system includes a user interface that is configured to receive a user query corresponding to a desired task to be performed on the platform. The system further includes an artificial intelligence (AI) driven module that is configured to provide guided support to the user for the desired task. The artificial intelligence (AI)-driven module is further configured to analyze the user query and identify one or more actions corresponding to the user query. The artificial intelligence (AI)-driven module is further configured to generate one or more videos and/or texts based on the identified actions to address the user query. The artificial intelligence (AI)-driven module is further configured to receive feedback from the user on the generated videos and/or texts via the user interface. The artificial intelligence (AI)-driven module is further configured to generate modified videos and/or texts based on the received feedback.

According to another example embodiment, a guided interactive user-support system for a platform is provided. The system includes a user interface that is configured to receive a user query corresponding to a desired task to be performed on the platform by a user. The user interface is further configured to receive a mode selection input from the user to address the user query. The mode selection input corresponds to either a guided support or an automated guided support. The system further includes an artificial intelligence (AI)-driven module that is configured to implement one of the guided support and the automated guided support based upon the received mode selection input. The artificial intelligence (AI)-driven module is further configured to analyze the user query and generate one or more videos and/or texts based upon the identified actions to address the user query in the guided support. The artificial intelligence (AI)-driven module is further configured to control a cursor of the platform to perform one or more tasks based on the generated modified videos and/or texts to perform the desired task on the platform in the automated guided support. The system further includes an output module that is configured to present the generated one or more videos and/or texts and other generated output to the user.

According to another example embodiment, a method for providing guided interactive user support for a platform is provided. The method includes receiving a user query corresponding to a desired task to be performed on the platform by a user. The method further includes receiving a mode selection input from the user to address the user query. The mode selection input corresponds to either a guided support or an automated guided support. The method further includes switching between the guided support and the automated guided support based upon the received mode selection input. The guided support implementation involves analyzing the user query to identify actions to address the user query and generating one or more videos and/or texts based upon the identified actions. The automated guided support implementation involves controlling a cursor of the platform to perform or guide towards one or more tasks based on the generated modified videos and/or texts to perform the desired task on the platform. The method further includes presenting the generated one or more videos and/or texts and other generated output to the user.

According to another example embodiment, a guided interactive user-support system for a platform is provided. The system includes a memory storing one or more processor-executable routines and a processor communicatively coupled to the memory. The processor is configured to execute one or more processor-executable routines to receive a user query corresponding to a desired task to be performed on the platform by a user. The processor is further configured to receive a mode selection input from the user to address the user query. The mode selection input corresponds to either a guided support or an automated guided support. The processor is further configured to implement one of the guided support or the automated guided support based upon the received mode selection input. The processor is further configured to analyze the user query and generate one or more videos and/or texts based upon the identified actions to address the user query in the guided support. The processor is further configured to control a cursor of the platform to perform one or more tasks based on the generated modified videos and/or texts to perform the desired task on the platform in the automated guided support. The processor is further configured to present the generated one or more videos and/or texts and other generated output to the user.

### BRIEF DESCRIPTION OF THE DRAWINGS

The disclosure will be described and explained with additional specificity and detail with the accompanying figures in which:

FIG. 1 is a block diagram representation of a guided interactive user-support system;

FIG. 2 is a flow chart illustrating the process of implementation of guided support mode using guided interactive user-support system 100 of FIG. 1;

FIG. 3 is a flow chart illustrating the process of implementation of automated guided support mode using guided interactive user-support system 100 of FIG. 1;

FIG. 4 is a representation an example screenshot of a guided support user interface of the guided interactive user-support system 100 of FIG. 1;

FIG. 5 is a representation an example screenshot of an automated guided support user interface and platform of the guided interactive user-support system 100 of FIG. 1;

FIG. 6 is a block diagram of an embodiment of a computing device in which the modules of the guided interactive user-support system, described herein, are implemented.

### DETAILED DESCRIPTION

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein. On the contrary, example embodiments are to cover all modifications, equivalents, and alternatives thereof.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Before discussing example embodiments in more detail, it is noted that some example embodiments are described as processes or methods depicted as flowcharts. Although the flowcharts describe the operations as sequential processes, many of the operations may be performed in parallel, concurrently, or simultaneously. In addition, the order of operations may be re-arranged. The processes may be terminated when their operations are completed but may also have additional steps not included in the figures. It should also be noted that in some alternative implementations, the functions/acts/steps noted may occur out of the order noted in the figures. For example, two figures shown in succession may, in fact, be executed substantially concurrently or may sometimes be executed in the reverse order, depending upon the functionality/acts involved.

Further, although the terms first, second, etc. may be used herein to describe various elements, components, regions, layers, and/or sections, it should be understood that these elements, components, regions, layers, and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the scope of example embodiments.

Spatial and functional relationships between elements (for example, between modules) are described using various terms, including “connected,” “engaged,” “interfaced,” and “coupled.” Unless explicitly described as being “direct,” when a relationship between the first and second elements is described in the description below, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular example embodiments only and is not intended to be limiting. Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless specifically stated otherwise, or as is apparent from the description, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

Embodiments of the invention provide a guided interactive user-support system for a platform designed to offer end-to-end user support. These embodiments address significant challenges of conventional user support systems that often lack real-time, context-sensitive assistance and require users to navigate separate interfaces or resources. The embodiments of the invention seamlessly integrate real-time support with user interactions, bridging the gap between user assistance and the operational aspects of the system. This allows users to receive immediate guidance, enhancing overall efficiency and user satisfaction.

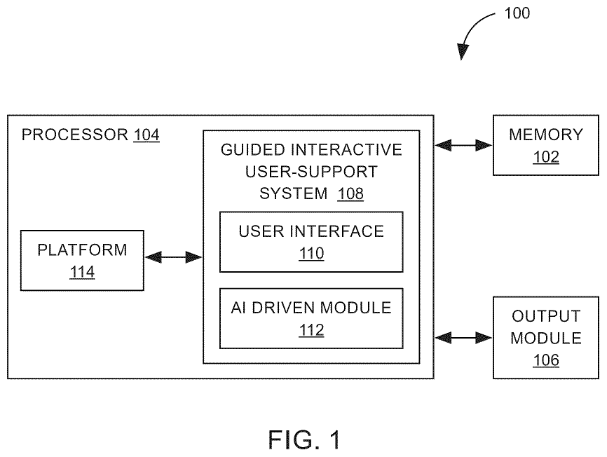

FIG. 1 is a block diagram 100 illustrating components of a guided interactive user-support system 108 for a platform 114 in accordance with embodiments of the invention. The system 100 includes a memory 102, a processor 104, and an output 106. The memory 102 is configured to store one or more processor-executable routines and the processor 104 is communicatively coupled to the memory 102 and is configured to execute the one or more processor-executable routines. In the example embodiment, the guided interactive user-support 108 includes a user interface 110 and an artificial intelligence (AI)-driven module 112.

The processor 104 is configured to facilitate guided interactive user support for the platform 114. The user interface 110 is configured to receive a user query corresponding to a desired task to be performed on the platform 114. The AI-driven module 112 is configured to provide guided support to the user based on the user inputs for the desired task.

The AI-driven module 112 is configured to analyze the user query and identify one or more actions corresponding to the user query. The AI-driven module 112 is further configured to generate one or more videos and/or texts based upon the identified actions to address the user query. In one embodiment, AI-driven module 112 is further configured to communicate with a repository (not shown) to generate the respective videos and/or texts. The user interface 110 allows users to provide feedback on generated content such as the videos and/or texts, and to generate modified videos and/or texts based upon the received feedback.

In another embodiment, AI-driven module 112 is configured to implement an automated guided support mode based on a mode selection input received from the user via user interface 110. In this mode, the AI-driven module 112 is further configured to control the cursor of the platform 114 to execute or guide towards one or more tasks automatically. The actions performed by the AI-driven module 112 are based on the modified videos and/or texts generated from the analysis of user queries in the guided support mode. The AI-driven module 112 is further configured to receive feedback from the user on the movement of the cursor to perform one or more tasks. The one or more tasks may include, but are not limited to, clicking, typing, dragging, scrolling, selecting, executing tasks, or combinations thereof. The AI-driven module 112 is further configured to modify the actions of the cursor based on the received feedback.

In some embodiments, the AI-driven module 112 is further configured to classify the user query based on a predetermined query classification system. This classification system enables the system 100 to categorize user queries into predefined categories or types, thereby facilitating more accurate and efficient assistance. In operation, the AI-driven module 112 is configured to identify one or more actions that are substantially relevant to the user query. The user query includes query selling information, performing operations on the platform 114, or combinations thereof. By aligning the user query with predetermined query classifications, the system 100 may effectively narrow down the range of potential actions needed to address the user's requirements. This classification and action identification process enhances the system's ability to provide tailored and targeted support to the users, streamlining the assistance process and improving user satisfaction.

In one embodiment, the AI-driven module 112 includes an AI support bot communicatively integrated with the platform 114. The AI support bot 112 is configured to leverage advanced machine learning algorithms and natural language processing (NLP) techniques to analyze and respond to user queries in real-time.

As described above, the system 100 is configured to operate in one of a guided support or automated guided support based upon a mode selection input provided by the user of the system 100. Such mode selection input may be provided via the user interface 110. The AI-driven module 112 is configured to analyze the user query and generate one or more videos and/or texts based upon the identified actions to address the user query in the guided support. Further, the AI-driven module 112 is configured to control a cursor of the platform 114 to perform one or more tasks based on the generated modified videos and/or texts to perform the desired task on the platform in the automated guided support. The generated videos and/or texts and other generated output is presented to the user via the output module 106.

In some embodiments, the AI-driven module 112 is configured to switch between the guided and automated guided supports at a given point in time while performing the desired task on the platform 114 based on user input. The examples process of the guided and automated guided support provided by the system 100 of FIG. 1 are described below.

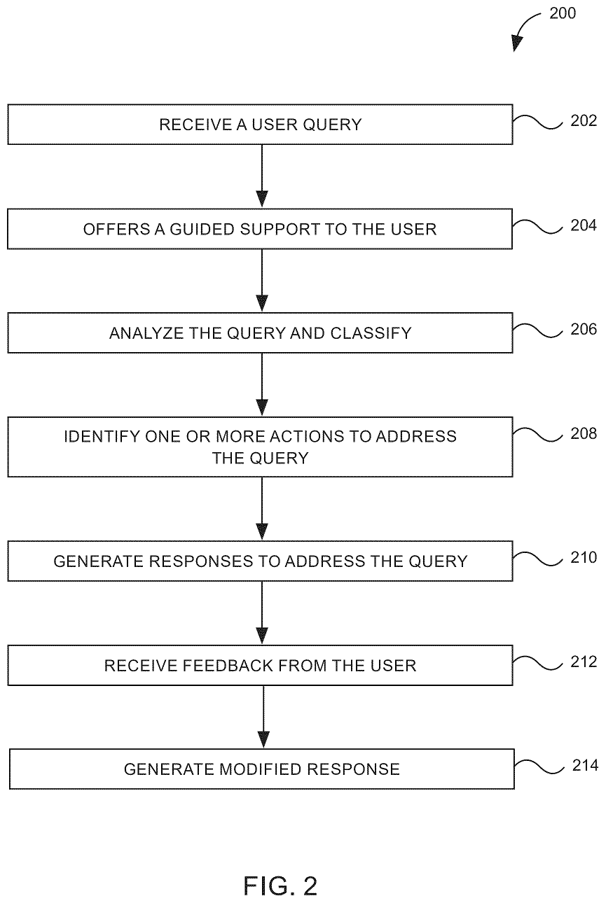

FIG. 2 is a flowchart illustrating an example process 200 of implementation of guided support according to embodiments of the invention using the guided interactive user-support system such as 100 of FIG. 1. At block 202, the system receives a user query via the user interface. The query corresponds to the desired tasks to be performed on the platform by the user. The user query may include a query seeking information, performing operations on the platform, or combinations thereof.

In some embodiments, the system receives a mode selection input from the user. The mode selection input corresponds to a guided support or an automated guided support. Based on the received mode selection input, the AI-driven module of the system offers guided support the user for performing the desired tasks on the platform (block 204).

In the guided support, the user query is analyzed to identify actions that address the user's query (block 206). The user query may be analyzed and classified based on a predetermined query classification. Upon classifying the user query, one or more actions that address the query are identified (block 208).

At 210, the AI-driven module may generate one or more videos and/or texts in response to the identified actions aimed at addressing the user query. These multimedia outputs are generated to align with the specific requirements of the user query, ensuring relevance and effectiveness in conveying information or instruction. In some embodiments, the AI-driven module initiates communication with a repository or with one or more external sources and/or platforms to access content, data, or instructions pertinent to the user queries and tasks and generate appropriate response such as videos and texts in response to the user query. Such generated videos and texts may be presented to the user for review.

At 212, the AI-driven module receives feedback from the user on the generated videos and/or texts via the user interface. By soliciting feedback, the system can assess user satisfaction and identify areas of improvement, facilitating continuous refinement and optimization of the response generation process. At 214, the AI-driven module utilizes the feedback received to generate modified versions of videos and/or texts. By incorporating user feedback into the content generation process, the system can enhance the accuracy, clarity, and utility of the materials produced, ultimately delivering a more personalized and effective user experience. This feedback mechanism enables the system to maintain relevance and quality over time, fostering greater user engagement and satisfaction with the platform.

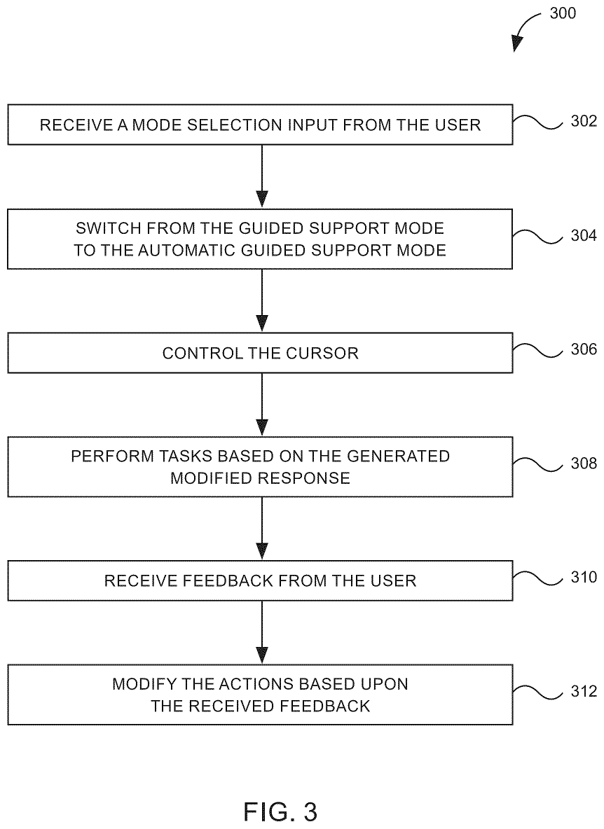

FIG. 3 is a flowchart illustrating an example process 300 of implementation of automated guided support according to some embodiments of the invention using the guided interactive user-support system such as 100 of FIG. 1. As described above, the system is designed to enhance user assistance by incorporating an automated guided support mode. In one of the embodiments, the user interface enables the user to input a command to select the mode of action for performing the desired task on the platform. The user mode selection for the automated guided support is received (block 302). At 304, a switch from the guided support to automated guided support is achieved based on the user input.

At block 306, the cursor of the system is controlled to execute or guide toward one or more tasks. The tasks encompass a range of interactive actions such as clicking, typing, dragging, scrolling, selecting, and executing commands and combinations thereof.

At 308, the generated videos and/or texts obtained from the guided mode are utilized to guide the cursor and perform the desired tasks on the platform efficiently. In guided support, the system may provide interactive guidance, offering step-by-step instructions or hints. However, upon activation of the automated guided support mode, the AI-driven module takes full control, utilizing the modified instructional media to complete tasks with minimal user intervention. This seamless transition from guided to automated guided support not only streamlines the user experience but also significantly reduces the potential for user errors, ensuring tasks are performed accurately and efficiently. The system's adaptability and precision in controlling the platform's interface exemplify its sophisticated design aimed at optimizing user productivity and satisfaction.

At block 310, feedback from the user is obtained on the movement of the cursor to perform one or more tasks via a user interface. At block 312, such feedback is utilized to modify the actions of the cursor. By incorporating user feedback into the automated guided mode, the system is configured to enhance the precision, efficiency, and relevance of the automated actions performed. This feedback loop mechanism allows the AI-driven module to continuously improve its performance in executing tasks such as clicking, typing, selecting, and executing commands. As a result, the system delivers a more personalized and effective user experience, maintaining high levels of user engagement and satisfaction. Over time, this iterative improvement process ensures that the automated guidance remains accurate and aligned with user needs, fostering sustained interaction and trust in the platform.

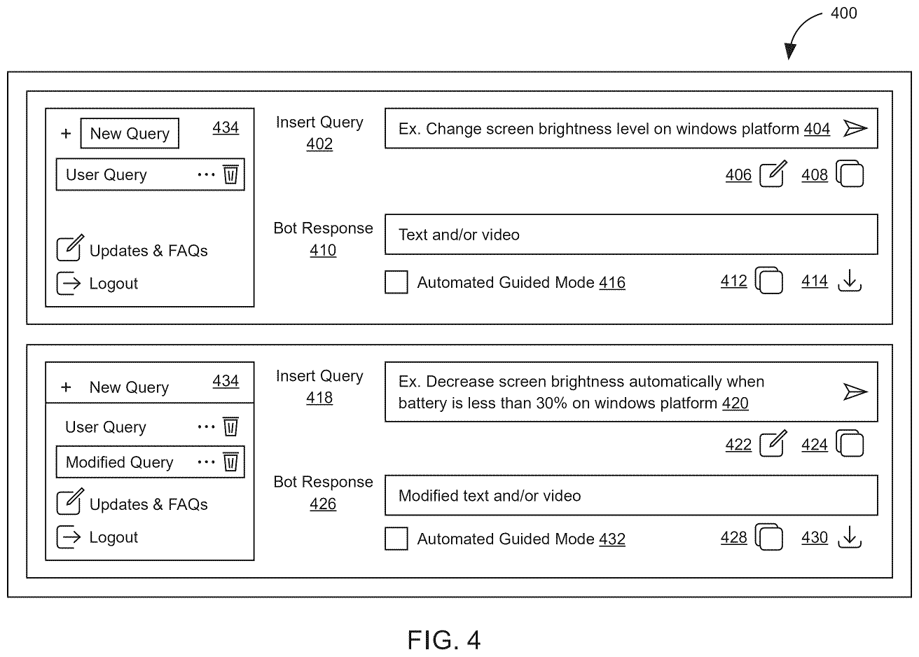

FIG. 4 illustrates an example screenshot 400 of a guided support user interface of the guided interactive user-support system 100 of FIG. 1, implemented according to some aspects of the invention.

In this example, a query 404 received from the user via the user interface 110 is processed to generate one or more responses. For instance, the example query “Change screen brightness level on windows platform” is received using a query input field 402. In this example, the user has the option to edit the query (406) and to copy the query (408). As noted above, the AI-driven module 112 is configured to process the query 404 and to generate responses in the form of videos and/or texts. The generated videos and/or texts are presented to the user via the bot response field 410 of the user interface 110. Here, the user has the option to download the response (414) or to copy the response (412).

In another example, feedback in the form of modified query 420 received from the user in the user interface 110 is processed to generate one or more modified responses. For instance, the example modified query “Decrease screen brightness automatically when the battery is less than 30% on windows platform” is received using the query input field 418. In this example, the user may edit the query 422 multiple times until they are satisfied with the response, and they have an option to copy the query (424). The generated modified videos and/or texts are presented to the user via the bot response field 426. Again, the user may download the modified response (430) and may copy the modified response (428).

In an embodiment, the guided support user interface 400 is configured to include an option to switch to automated guided mode, represented by fields 416 & 432. The user may provide mode selection input to generate desired responses on the platform.

In certain embodiments, the user may select various options that pop up on the left side of the user interface 110 to perform desired operations, such as represented by reference numeral 434. For instance, the available options are new query, user query, modified user query, updates & FAQs, and log out.

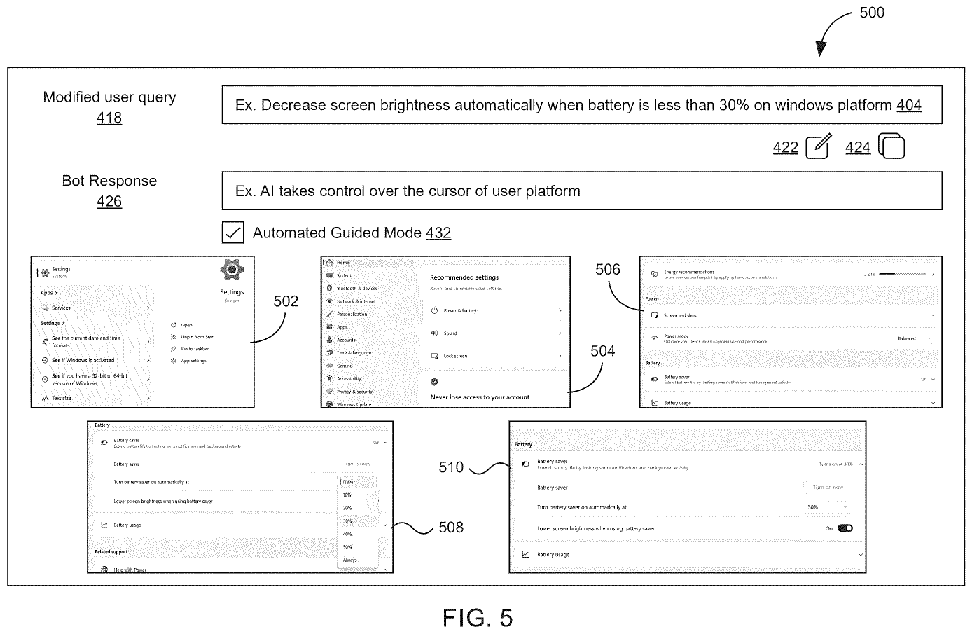

FIG. 5 illustrates an example screenshot 500 of an automated guided support user interface and the platform of the guided interactive user-support system 100 of FIG. 1, implemented according to the aspects of the present invention.

In this example, the modified user query 418 received from the user via the user interface 110 is processed to generate one or more responses. In an embodiment, the user interface 110 includes an option to switch to the automated guided mode (432). The user can provide the mode selection input to activate the automated guided mode 432. As noted above, in automated guided mode, the AI-driven module 112 takes control over the cursor of the platform to perform the desired task autonomously.

The AI-driven module 112 is configured to control the cursor of the user platform 114 to perform the tasks automatically using generated modified videos and/or texts shown in the bot response field 426. The cursor is configured to automatically move following instructions such as clicking, typing, dragging, scrolling, selecting, and executing commands as directed by generated videos and/or texts.

The example query “Decrease screen brightness automatically when the battery is less than 30% on windows platform” is addressed by the automated guided mode. On the platform 114, the cursor clicks on the windows button on the keyboard and uses the typing command to enter “settings.” This action opens the web interface 502 on the display, and the cursor clicks on “Settings.” Subsequently, the web interface 504 is displayed, and the cursor clicks on “Power and Battery.” Next, the web interface 506 is displayed, and the cursor clicks on “Battery Saver.” Following this, the web interface 508 is displayed, and the cursor clicks on “Turn Battery Saver on automatically,” where various options pop up. The cursor then selects 30% from the options as per the command. Finally, the web interface 510 presents the confirmation that the task is executed. This example describes the functionality of the automated guided mode in guided interactive user-support system 100.

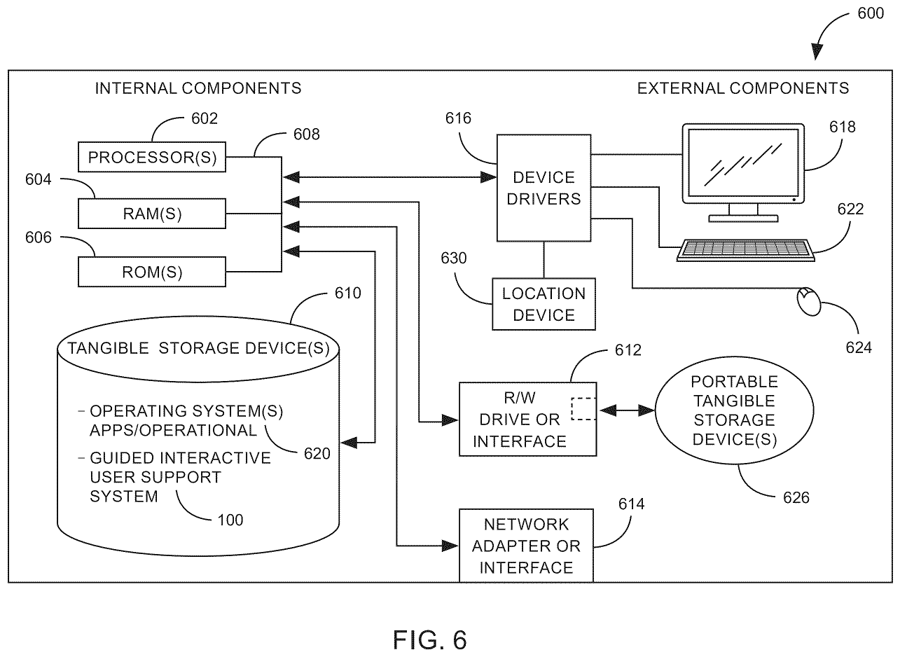

The modules of the guided interactive user-support system 100, described herein, are implemented in computing devices to facilitate user assistance and task execution. One example of a computing device 600 is described below in FIG. 6. The computing device 600 includes one or more processor(s) 602, one or more computer-readable RAMs 604, and one or more computer-readable ROMs 606 on one or more buses 608. Further, the computing device 600 includes a tangible storage device 610 that may be used to execute operating systems 620 and the guided interactive user-support system 100. The various modules of the guided interactive user-support system 100 may be stored in the tangible storage device 610. Both, the operating systems 620 and the guided interactive user-support system 100 are executed by one or more processor(s) 602 via one or more respective RAMs 604 (which typically include cache memory). The execution of the operating systems 620 and/or the guided interactive user-support system 100 by the one or more processor(s) 602, configures the one or more processor(s) 602 as a special purpose processor configured to carry out the functionalities of the operation systems 620 and/or the guided interactive user-support system 100 as described above.

Examples of tangible storage devices 610 include semiconductor storage devices such as ROM, EPROM, flash memory, or any other computer-readable tangible storage device that may store a computer program and digital information.

The computing device 600 also includes an R/W drive or interface 614 to read from and write to one or more portable computer-readable tangible storage devices 628 such as a CD-ROM, DVD, memory stick, or semiconductor storage device. Further, network adapters or interfaces 612 such as TCP/IP adapter cards, wireless Wi-Fi interface cards, or 3G or 4G wireless interface cards, or other wired or wireless communication links are also included in computing devices.

In one example embodiment, the guided interactive user-support system 100 may be stored in the tangible storage device 610 and may be downloaded from an external computer via a network (for example, the Internet, a local area network, or other, wide area network) and network adapter or interface 612.

Computing device 600 further includes device drivers 616 to interface with input and output devices. The input and output devices may include a computer display monitor 618, a keyboard 622, a keypad, a touch screen, a computer mouse 624, and/or some other suitable input device.

In this description, including the definitions mentioned earlier, the term ‘module’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware. The term code, as used above, may include software, firmware, and/or microcode, and may refer to programs, routines, functions, classes, data structures, and/or objects.

Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above. Shared memory hardware encompasses a single memory device that stores some or all code from multiple modules. Group memory hardware encompasses a memory device that, in combination with other memory devices, stores some or all code from one or more modules.

In some embodiments, the module may include one or more interface circuits. In some examples, the interface circuits may include wired or wireless interfaces that are connected to a local area network (LAN), the Internet, a wide area network (WAN), or combinations thereof. The functionality of any given module of the present description may be distributed among multiple modules that are connected via interface circuits. For example, multiple modules may allow load balancing. In a further example, a server (also known as remote, or cloud) module may accomplish some functionality on behalf of a client module.

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

While only certain features of several embodiments have been illustrated, and described herein, many modifications and changes will occur to those skilled in the art. It is, therefore, to be understood that the appended claims are intended to cover all such modifications and changes as fall within the true spirit of inventive concepts.

The aforementioned description is merely illustrative in nature and is in no way intended to limit the disclosure, its application, or its uses. The broad teachings of the disclosure may be implemented in a variety of forms. Therefore, while this disclosure includes particular examples, the true scope of the disclosure should not be so limited since other modifications will become apparent upon a study of the drawings, and the specification. It should be understood that one or more steps within a method may be executed in different order (or concurrently) without altering the principles of the present disclosure. Further, although each of the example embodiments is described above as having certain features, any one or more of those features described with respect to any example embodiment of the disclosure may be implemented in and/or combined with features of any of the other embodiments, even if that combination is not explicitly described. In other words, the described example embodiments are not mutually exclusive, and permutations of one or more example embodiments with one another remain within the scope of this disclosure.

The example embodiment or each example embodiment should not be understood as a limiting/restrictive of inventive concepts. Rather, numerous variations and modifications are possible in the context of the present disclosure, in particular those variants and combinations which may be inferred by the person skilled in the art with regard to achieving the object for example by combination or modification of individual features or elements or method steps that are described in connection with the general or specific part of the description and/or the drawings, and, by way of combinable features, lead to a new subject matter or to new method steps or sequences of method steps, including insofar as they concern production, testing and operating methods. Further, elements and/or features of different example embodiments may be combined with each other and/or substituted for each other within the scope of this disclosure.

Still further, any one of the above-described and other example features of example embodiments may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Further, at least one example embodiment relates to a non-transitory computer-readable storage medium comprising electronically readable control information (e.g., computer-readable instructions) stored thereon, configured such that when the storage medium is used in a controller of a magnetic resonance device, at least one example embodiment of the method is carried out.

Even further, any of the aforementioned methods may be embodied in the form of a program. The program may be stored on a non-transitory computer readable medium, such that when run on a computer device (e.g., a processor), cause the computer device to perform any one of the aforementioned methods. Thus, the non-transitory, tangible computer readable medium is adapted to store information and is adapted to interact with a data processing facility or computer device to execute the program of any of the above-mentioned embodiments and/or to perform the method of any of the above-mentioned embodiments.

The computer readable medium or storage medium may be a built-in medium installed inside a computer device's main body or a removable medium arranged so that it may be separated from the computer device's main body. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include but are not limited to, rewriteable non-volatile memory devices (including, for example, flash memory devices, erasable programmable read-only memory devices, or mask read-only memory devices), volatile memory devices (including, for example, static random access memory devices or a dynamic random access memory devices), magnetic storage media (including, for example, an analog or digital magnetic tape or a hard disk drive), and optical storage media (including, for example, a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The apparatuses and methods described in this application may be partially or fully implemented by a special purpose computer created by configuring a general-purpose computer to execute one or more particular functions embodied in computer programs. The functional blocks and flowchart elements described above serve as software specifications, which may be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

We claim:

1. A guided interactive user-support system for a platform, wherein the system comprises:
a user interface configured to receive a user query corresponding to a desired task to be performed on the platform; and
an artificial intelligence (AI)-driven module configured to provide guided support to the user for the desired task, wherein the AI-driven module is further configured to:
analyze the user query and identify one or more actions corresponding to the user query;
generate one or more videos and/or texts based upon the identified actions to address the user query, wherein the AI-driven module is further configured to communicate with a repository to generate the respective videos and/or texts;
receive feedback from the user on the generated videos and/or texts via the user interface; and
generate modified videos and/or texts based upon the received feedback.

2. The guided interactive user-support system of claim 1, wherein the AI-driven module is further configured to classify the user query based on a pre-determined query classification and to identify the one or more actions based on the query classification.

3. The guided interactive user-support system of claim 1, wherein the system is further configured to switch to an automated guided support, wherein the AI-driven module is configured to control a cursor of the platform to perform or guide towards one or more tasks based on the generated modified videos and/or texts to perform the desired task on the platform.

4. The guided interactive user-support system of claim 3, wherein the system receives an input from the user via the user interface to switch to the automated guided support.

5. The guided interactive user-support system of claim 4, wherein the user interface is configured to receive feedback from the user on the movement of the cursor to perform or guide toward the one or more tasks.

6. The guided interactive user-support system of claim 5, wherein the AI-driven module is configured to modify the actions of the cursor based on the received feedback.

7. The guided interactive user-support system of claim 3, wherein the one or more tasks comprise clicking, typing, dragging, scrolling, selecting, executing tasks, or combinations thereof.

8. A guided interactive user-support system for a platform, wherein the system comprises:
a user interface configured to:
receive a user query corresponding to a desired task to be performed on the platform by a user; and
receive a mode selection input from the user to address the user query, wherein the mode selection input corresponds to a guided support or an automated guided support; and
an artificial intelligence (AI)-driven module configured to implement one of the guided support and the automated guided support based upon the received mode selection input, wherein the AI-driven module is further configured to:
analyze the user query and generate one or more videos and/or texts based upon the identified actions to address the user query in the guided support; and
control a cursor of the platform to perform or guide toward one or more tasks based on the generated modified videos and/or texts to perform the desired task on the platform in the automated guided support; and
an output module configured to present the generated one or more videos and/or texts and other generated output to the user.

9. The guided interactive user-support system of claim 8, wherein the user interface is configured to receive input from the user to switch between the guided and automated guided supports at a given point in time while performing the desired task on the platform.

10. The guided interactive user-support system of claim 8, wherein the AI-driven module is further configured to communicate with a repository to generate the respective videos and/or texts based on the user query.

11. The guided interactive user-support system of claim 8, wherein the AI-driven module is further configured to:
receive feedback from the user on the generated videos and/or texts via the user interface in the guided mode; and
generate modified videos and/or texts based upon the received feedback.

12. The guided interactive user-support system of claim 8, wherein the AI-driven module is configured to modify the actions of the cursor based on the received feedback.

13. The guided interactive user-support system of claim 12, wherein the actions of the cursor comprise clicking, typing, dragging, scrolling, selecting, executing tasks, or combinations thereof.

14. The guided interactive user-support system of claim 8, wherein the user query comprises a query seeking information, performing operations on the platform, or combinations thereof.

15. The guided interactive user-support system of claim 8, wherein the artificial intelligence (AI)-driven module comprises an AI support bot communicatively integrated with the platform.

16. A method for providing guided interactive user support for a platform, the method comprising:
receiving a user query corresponding to a desired task to be performed on the platform by a user;
receiving a mode selection input from the user to address the user query, wherein the mode selection input corresponds to a guided support or an automated guided support; and
switching between the guided support and the automated guided support based upon the received mode selection input, wherein implementing the guided support comprises analyzing the user query to identify actions to address the user query and generating one or more videos and/or texts based upon the identified actions; and
wherein implementing the automated guided support comprises controlling a cursor of the platform to perform or guide towards one or more tasks based on the generated modified videos and/or texts to perform the desired task on the platform; and
presenting the generated one or more videos and/or texts and other generated output to the user.

17. The method of claim 16, wherein controlling the cursor of the platform comprises performing one or more of clicking, typing, dragging, scrolling, selecting, executing tasks, or combinations thereof.

18. The method of claim 16, further comprising:
communicating with one or more external sources and/or platforms to generate the videos and/or texts to address the user query;
receiving inputs from the user on the generated videos and/or texts; and
modifying the generated videos and/or texts based on the received inputs.

19. The method of claim 16, wherein implementing the guided and/or the automated guided support further comprises using an AI-driven module coupled to the platform.

20. A guided interactive user-support system for a platform, wherein the system comprises:
a memory storing one or more processor-executable routines; and
a processor communicatively coupled to the memory, the processor configured to execute the one or more processor-executable routines to:
receive a user query corresponding to a desired task to be performed on the platform by a user; and
receive a mode selection input from the user to address the user query, wherein the mode selection input corresponds to a guided support or an automated guided support; and
implement one of the guided support or the automated guided support based upon the received mode selection input, wherein the processor is further configured to:
analyze the user query and generate one or more videos and/or texts based upon the identified actions to address the user query in the guided support; and
control a cursor of the platform to perform or guide towards one or more tasks based on the generated modified videos and/or texts to perform the desired task on the platform in the automated guided support; and
present the generated one or more videos and/or texts and other generated output to the user.
